(19) United States
(12) Patent Application Publication
(10) Pub. No.: US 2004/0004767 A1
(43) Pub. Date: Jan. 8, 2004

(54) Wearable display system adjusting magnification of an image

(75) Inventor: Young-ran Song, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/418,295

(22) Filed: Apr. 18, 2003

(30) Foreign Application Priority Data
May 13, 2002 (KR) 2002-26158

(51) Int. Cl. G02B 5/18; G02B 27/44

(52) U.S. Cl. 359/566

(57) ABSTRACT

A wearable display system to display an input image signal includes an objective lens, a grating, a waveguide, and an ocular lens. The objective lens magnifies the input image signal and the grating refracts the input image signal magnified by the objective lens at a predetermined angle. The waveguide transmits the input image signal refracted by the grating and the ocular lens magnifies the transmitted input image allowing a user to see the input image signal.

### CROSS-REFERENCE TO RELATED APPLICATIONS

This application claims the priority of Korean Patent Application No. 2002-26158, filed on May 13, 2002, in the Korean Intellectual Property Office, the disclosure of which is incorporated herein in its entirety by reference.

### BACKGROUND OF THE INVENTION

1. Field of the Invention

The present invention relates to a display system, and more particularly, to a wearable display system in which an order of magnification of an image can be adjusted using a microscope principle.

2. Description of the Related Art

A wearable display system generally known as a head or helmet mounted display (HMD) system is increasingly used as an optical display system for military, medical, or personal display applications. Such HMD system includes a wearable device like glasses, goggles, or a helmet via which a user can watch image signals. It is one of the advantages of the wearable HMD system that the user can receive image information even when the user is moving.

FIG. 1 shows a conventional HMD system. As shown in FIG. 1, the HMD system generally includes glass lenses 100 and an image-producing unit 110 provided at a center of the glass lenses 100. As can be seen in FIG. 1, the image-producing unit 100 is outstandingly bulky and heavy, and it does not look good when considering an overall appearance of the HMD system. Such a bulky and heavy structure of the image-producing unit 110 is mainly due to numerous optical devices incorporated therein.

FIG. 2 is a block diagram showing the structure of the conventional HMD system. As shown in FIG. 2, the HMD system includes an image-producing unit 200, a display panel 210, and an optical system 220. The image-producing unit 200 receives and stores the image signals provided from an external source such as a personal computer or a video player (not shown), and processes the received image signals to display an image on the display panel 210, such as an LCD panel. The optical system 220 magnifies, via a magnifying optics system, the image displayed on the display panel 210 to produce a virtual image that is shown to a user's eyes in an adequately magnified size. Meanwhile, the HMD system may additionally include peripheral devices, such as a support member allowing the user to wear the HMD system, or a wire for receiving the image or other signals from the external sources.

FIG. 3 shows a structure of a conventional optical system incorporated in the conventional HMD system shown in FIG. 2. As shown in FIG. 3, the conventional optical system includes a collimating lens 300, an X-prism 310, left and right focusing lenses 320, reflecting mirrors 330, and ocular or magnifying lenses 340. The collimating lens 300 transduces light, i.e., an image signal, emitted from a source of light such as the display panel 210 into a beam of light, i.e., a parallel light, and transmits the light beam to the X-prism 310. The X-prism 310 divides the light beam transmitted from the collimating lens 300 into two spectral beams directed leftward and rightward, respectively, and transmits the two spectral beams to the left and right focusing lenses 320, placed with respect to the X-prism 310. The focusing lenses 320 focus the spectral beams, and the reflecting mirrors 330 redirect the focused beams. The redirected beams progress toward the user's eyes through the ocular or magnifying lenses 340. The ocular lenses 340 magnify the image signal that has been emitted from the display panel and passed through the above-described optical devices so that magnified images are ultimately shown to the user's eyes. In the event that the image signal is a color signal, such a type of lenses that can remove chromatic aberration should be used as the ocular lenses 340.

As described above, the conventional optical system of the conventional wearable display system, such as the HMD, incorporates numerous optical devices, such as the collimating lens 300, the X-prism 310, the focusing lens 320, the reflecting mirrors 330, and the ocular lenses 340, all requiring high precision. In view of characteristics of the optical devices requiring high precision, it is extremely hard to embody the optical devices in an optical system, and a lot of time and endeavor is needed to fabricate the optical system. Even though the individual optical devices are precisely designed, there is a difficulty to precisely assemble the optical devices with each other. Further, as already mentioned with reference to FIG. 1, the conventional optical system or the image-producing unit incorporating the optical system is considerably bulky and heavy because of the numerous optical devices. Therefore, it is inconvenient for the user to wear the HMD system. Moreover, production cost of the HMD system increases due to the numerous optical devices and the difficulties in fabricating the optical system.

Meanwhile, the wearable display system that is capable of displaying the color images has not been yet commercialized. However, it is expected that demands on such wearable display system capable of displaying color images would increase, and accordingly, a necessity for developing a wearable color display system arises.

### SUMMARY OF THE INVENTION

According to an aspect of the present invention, there is provided a wearable display system in which an order of magnification of an image can be adjusted using a minimal number of optical devices by adapting a microscope principle.

According to an aspect of the present invention, there is further provided a wearable color display system in which an order of magnification of a color image can be adjusted using a minimal number of optical devices by adapting a microscope principle.

According to an aspect of the present invention, there is provided a wearable display system to display an input image signal, which includes an objective lens magnifying the input image signal; a grating refracting the input image signal magnified by the objective lens at a predetermined angle; a waveguide transmitting the input image signal refracted by the grating; and an ocular lens making an image corresponding to the input image signal transmitted via the waveguide, allowing a user to see the input image signal.

According to an aspect of the present invention, an order of magnification of the image signal can be adjusted by varying focusing distances of the objective lens and/or the ocular lens.

According to an aspect of the present invention, the objective lens is movable to an input direction of the input image signal to adjust an order of magnification.

According to an aspect of the present invention, the waveguide is movable to the input direction of the image signal to adjust the order of magnification.

According to an aspect of the present invention, the waveguide includes a coating plate of a highly reflective material to reflect and transmit the input image signal.

According to an aspect of the present invention, the grating is a hologram optics element.

According to an aspect of the present invention, the input image signal is produced at a focusing distance of the objective lens.

According to another aspect of the present invention, there is provided a wearable color display system to display red (R), green (G), and blue (B) color components of input image signals, which includes an objective lens magnifying the R, G, and B input image signals; a grating refracting the R, G, and B color components of the input image signals magnified by the objective lens at predetermined angles; a waveguide transmitting the R, G, and B color components of the input image signals refracted by the grating; and an ocular lens making an image corresponding to the R, G, and B color components of the input image signals transmitted via the waveguide, allowing a user to see the input image signals.

According to an aspect of the present invention, orders of magnification of the R, G, and B color components of the input image signals are adjusted by varying focusing distances of the objective lens and/or the ocular lens.

According to an aspect of the present invention, the objective lens is movable to an input direction of the R, G, and B color components of the input image signals to adjust orders of magnification.

According to an aspect of the present invention, the waveguide is movable to an input direction of the R, G, and B color components of the input image signals to adjust orders of magnification.

According to an aspect of the present invention, the waveguide includes a coating plate of a highly reflective material to reflect and transmit the R, G, and B color components of the input image signals.

According to an aspect of the present invention, the grating is a hologram optics element.

According to an aspect of the present invention, the R, G, and B color components of the input image signals are produced at a focusing distance of the objective lens.

According to an aspect of the present invention, the grating is a multiplexing type grating to respectively refract the R, G, and B color components of the image signals at different angles from each other according to corresponding wavelengths, where the R, G, and B color components of the input image signals respectively move at constant distances within the waveguide.

According to an aspect of the present invention, the grating is a lamination type grating having layers laminated in a predetermined order, where each layer refracts only one of the R, G, and B color components of the input image signals at an angle predetermined in accordance with corresponding wavelengths of the R, G, and G color components of the input image signals.

According to an aspect of the present invention, the ocular lens is a multiplexing type lens to respectively refract and output the R, G, and B color components of the image signals at different angles from each other according to corresponding wavelengths, where the R, G, and B color components of the input image signals converge to an identical focus to make a combined image.

According to an aspect of the present invention, the ocular lens is a lamination type lens having layers laminated in a predetermined order where, each of which refracts only one of the R, G, and B input image signals at an angle predetermined in accordance with corresponding wavelengths, and the R, G, and B color components of the image signals respectively refracted via the corresponding layer converge to an identical focus to make a combined image.

These together with other aspects and advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

These and/or other objects and advantages of the invention will become apparent and more readily appreciated from the following description of the embodiments, taken in conjunction with the accompanying drawings of which:

FIG. 1 shows a conventional HMD system;

FIG. 2 is a block diagram showing a structure of the conventional HMD system;

FIG. 3 shows a structure of a conventional optical system incorporated in the conventional HMD system shown in FIG. 2;

FIG. 4 shows a structure of a wearable color display system, according to an aspect of the present invention;

FIG. 5 illustrates a principle of a microscope employed in the wearable display system, according to an aspect of the present invention;

FIGS. 6a to 6d show various aspects of the wearable display system, according to the present invention;

FIGS. 7a to 7d show various aspects of the wearable display system, according to the present invention;

FIG. 8 shows an aspect of a wearable color display system according to the present invention, to display color signals or R, G, and B color components of image signals; and

FIG. 9 shows an assembly of a waveguide, a grating, and a lamination type ocular lens incorporated in the wearable color display system to display the color signals or the R, G, and B color components of the image signals shown in FIG. 8.

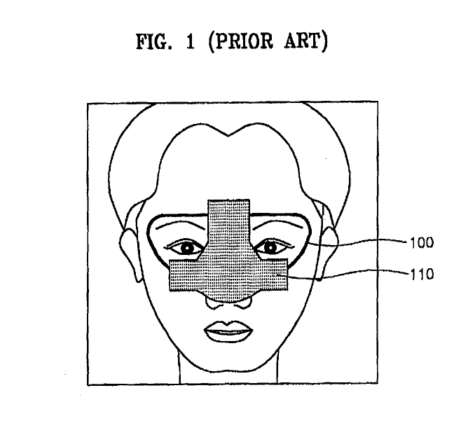

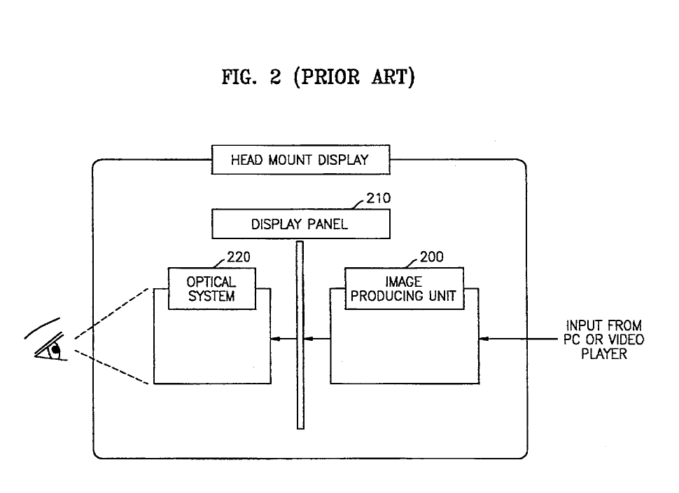

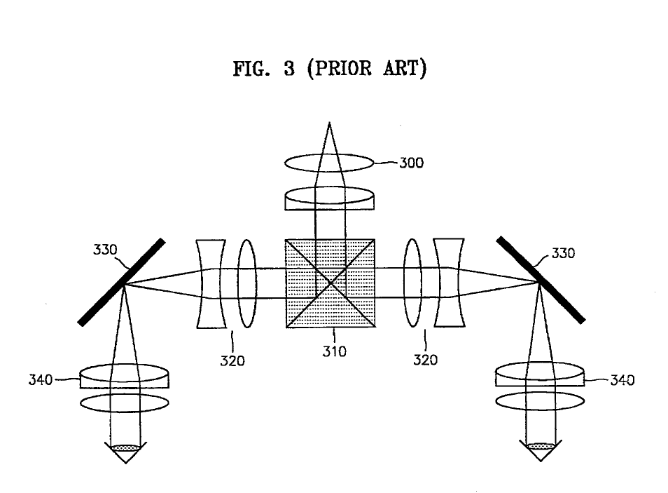

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

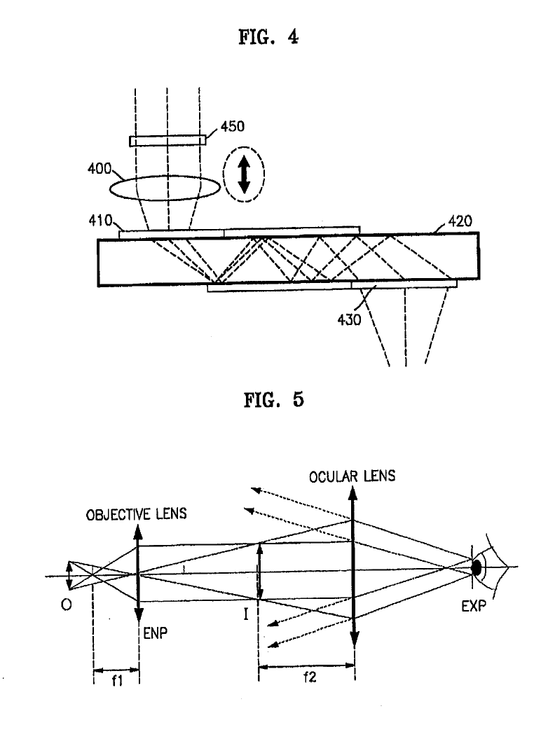

A wearable display system according to an aspect of the present invention includes an objective lens 400, a grating 410, and an ocular lens system 430, as shown in FIG. 4.

The objective lens 400 is one of the elements to implement a microscope principle to be described below, and magnifies an image 450 of an object existing out of a focus or a signal to the opposite side thereof. The objective lens 400 is movable using a support member (not shown) in a direction identical to a progressing direction of the signal. A movement of the objective lens 400 is performed to adjust an order of magnification of, e.g., an input image signal, according to an aspect of the present invention. The movement of the objective lens 400 can be carried out manually by a user, or automatically using a control unit (not shown).

The grating 410 is attached to the surface of a waveguide 420, and refracts the image signal magnified by the objective lens 400 at a predetermined angle. Then, the image signal is inputted into the waveguide 420. The grating 410 includes a pre-carved pattern to determine a diffraction angle in accordance with a wavelength of the input image signal.

The waveguide 420 serves as a signal transmission medium for transmitting therein the image signal inputted through the grating 410. When the image signal to be transmitted through the waveguide 420 collide s against an inner side of the waveguide 420, the image signal may be reflected without any loss where a total reflection of the signal is achieved. Actually, the image signal is subject to a considerable loss. Therefore, in order to prevent the loss of the image signal, a high reflective material such as aluminum (Al) is coated on portions of the inner side of the waveguide 420 where the image signal is collided during the transmission of the image signal within the waveguide.

An ocular lens 430 is attached to the surface of the waveguide 420, and outputs the image signal transmitted through the waveguide 420. The ocular lens is another element to implement a microscope principle to be described below. When an image is made from the image signal magnified by the objective lens 400 within a focusing distance of the ocular lens 430, the ocular lens 430 magnifies and shows the image to the user. To raise an order of magnification of the image, the focusing distance of the ocular lens 430 may be reduced. In order to reduce the focusing distance, a diameter of the ocular lens 430 is reduced. However, according to an aspect of the present invention, because an order of magnification can be raised or lowered using the objective lens 400, i.e., by adjusting the focusing distance of the objective lens 400, the ocular lens 430 can have a sufficiently large diameter to ensure visibility of a user's eye, i.e., an exit pupil. In addition to the above-described way to move the position of the objective lens to vary the focusing distance of the objective lens 400 and the ocular lens 430 to adjust the order of magnification, there is another way to move the waveguide while the objective lens is kept fixed.

In the aspect of the present invention described above, the grating 410 may be integrated with the waveguide 420, or implemented using a hologram optics element (HOE). The ocular lens also may be integrated with the waveguide 420, or implemented using the HOE.

FIG. 5 illustrates a principle of a microscope structure employed in the wearable display system, according to an aspect of the present invention. Referring to FIG. 5 in connection with FIG. 4, the image or object 450 produced by a display panel or the like is indicated by a reference symbol O in FIG. 5. The image 450 or the object O is placed out of a focusing distance f1 of the objective lens 400. If the image is illuminated by a light beam and projected to the objective lens 400, the objective lens magnifies the image signal and makes a real image at a predetermined position within the waveguide 420. The real image is indicated by a reference symbol I in FIG. 5. The location of the ocular lens 430 is determined such that the real image I is produced within a focusing distance f2 of the ocular lens 430. The user EXP can see a magnified real image via the ocular lens 430.

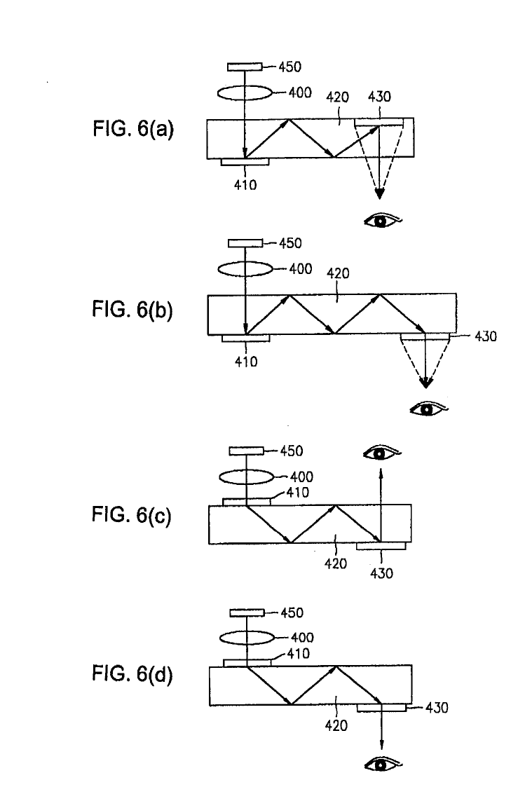

FIGS. 6(a) to 6(d) show another aspect of the wearable display system according to the present invention. The aspect shown in FIG. 6(a) includes the objective lens 400, the grating 410, the waveguide 420, and the ocular lens 430, like the aspect shown in FIG. 4. Each of the elements of the aspect shown in FIG. 6(a) has an identical function to that of the corresponding element described with reference to FIG. 4. However, in the aspect shown in FIG. (6a), the grating 410 is placed across the waveguide 420, i.e., on an opposite surface of the waveguide 420, to a surface where the image signal is inputted. The grating 410 for the aspect shown in FIG. (6a) is a reflection type grating to reflectively diffract the input image signal toward an inside of the waveguide 420, at a predetermined angle. Likewise, the ocular lens 430 in the aspect shown in FIG. (6a) is a reflection type lens to reflect and output the input image signal toward an outside of the waveguide 420.

FIG. 6(b) shows another aspect of the wearable display system, according to an aspect of the present invention, which incorporates the grating 410 of the reflection type and the ocular lens 430 being of a transmission type.

FIG. 6(c) shows another aspect of the wearable display system, according to the present invention, which incorporates the grating 410 of the transmission type and the ocular lens 430 of the reflection type. FIG. 6(d) shows another aspect of the wearable display system according to the present invention, which includes the transmission type grating 410 and the transmission type ocular lens 430.

Although not shown in FIGS. (6a) to 6(d), a high reflection material can be coated on the inner sides of the waveguide 420, entirely or partially at particular portions where the image signal is collided, for total reflection of the image signal to be transmitted within the waveguide 420.

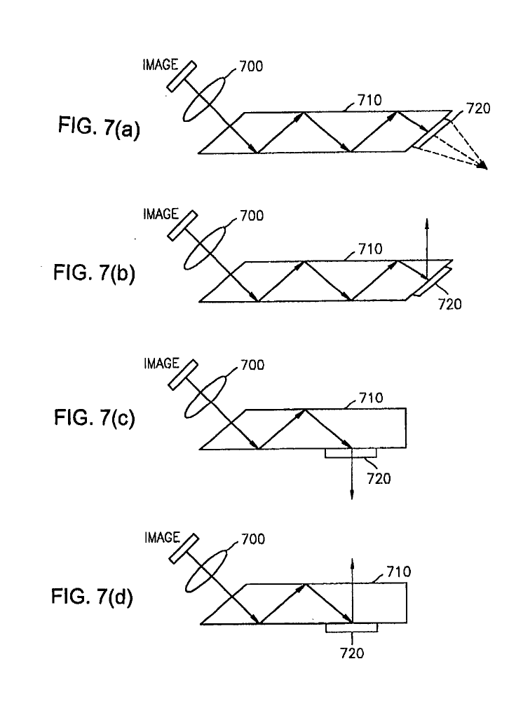

FIGS. 7(a) to 7(d) show other aspects of the wearable display system according to the present invention.

The aspect shown in FIG. 7(a) includes an objective lens 700, a waveguide 710, and an ocular lens 720. The objective lens 700 is embodied in accordance with the above-described microscope principle, and magnifies the image existing out of a focusing distance thereof. The objective lens 700 is movable using a certain support member (not shown) in the direction identical to an input direction of the image signal. The movement of the objective lens 700 is performed for an adjustment of magnification of, for instance, the input image signal, and is carried out manually by the user, or automatically via a control unit (not shown).

The waveguide 710 serves as a signal transmission medium to transmit the image signal magnified by the objective lens 700 and inputted through a side surface of the waveguide 710 inclined at a predetermined angle. The image signal may be reflected without any loss where a total reflection of the image signal occurs when the image signal to be transmitted through the waveguide 710 collides against the inner surface of the waveguide 710. Actually, the image signal is subject to a considerable loss. Therefore, in order to prevent the loss of the image signal, a high reflection material such as aluminum (not shown) is coated on the portions of an inner surface of the waveguide 710 where the image signal collide s during the transmission of the signal within the waveguide 710.

The ocular lens 720 outputs the image signal transmitted via the waveguide 710. The ocular lens 720 is arranged in accordance with the above-described microscope principle. When an image is made from the image signal magnified by the objective lens 700 within a focusing distance of the ocular lens 720, the ocular lens 720 magnifies and shows the image to the user. To raise an order of magnification of the image, the focusing distance of the ocular lens 720 may be reduced. In order to reduce the focusing distance, a diameter of the ocular lens 720 may be reduced. However, in the aspect shown in FIG. 7(a), because an order of magnification can be raised or lowered using the objective lens 700, i.e., by adjusting the focusing distance of the objective lens 700, the ocular lens 720 can have a sufficiently large diameter to ensure visibility of the user's eye, i.e., the exit pupil. Further, in the aspect shown in FIG. 7(a), the ocular lens 720 is a transmission type ocular lens that is attached on the opposite side to the incidence side of the image signal, and has the same slope to that of the incidence side.

FIG. 7(b) shows another aspect including the same elements to the aspect of FIG. 7(a), wherein the ocular lens 720 reflects the image signal at a predetermined angle and then outputs the image signal outside of the waveguide 710.

FIGS. 7(c) and 7(d) show other aspects having the transmission type and the reflection type ocular lens 720 attached to one of the surfaces connected to the side of the waveguide 710, respectively.

In the aspects shown in FIGS. 7(a) to 7(d), the ocular lens 720 may be integrated with the waveguide 710 and implemented using a hologram optics element.

FIG. 8 shows an aspect of a wearable color display system according to the present invention to display color signals or red (R), green (G), and blue (B) color components of the image signals. Referring to FIG. 8, the wearable color display system, according to an aspect of the present invention includes an objective lens 800, a grating 810, a waveguide 820, and an ocular lens 830. The R, G, and B color components of the image signals are respectively emitted from light emitting diodes (LEDs) 81. A color filter 82 respectively filters the wavelengths of the color components emitted from the LEDs 81, and narrows bandwidths of the wavelengths. A collimating lens 83 outputs the filtered R, G, and B color components of the signals as parallel beams.

The objective lens 800 is placed in accordance with the above-described microscope principle, and magnifies an image 80 of the R, G, and B color components of the image signals out of a focusing distance of the objective lens to the opposite side thereof. The objective lens 800 is movable using a support member (not shown) in a direction identical to the image signal input direction. The movement of the objective lens 800 is performed to adjust an order of magnification of, e.g., the input image signal according to an aspect of the present invention. The movement of the objective lens 800 can be carried out manually by the user, or automatically using a control unit (not shown).

The grating 810 is attached on a side of the waveguide 820, and refracts the R, G, and B color components of the image signals magnified by the objective lens 800 at predetermined angles, which are inputted into the waveguide 820. The grating 810 has a pre-carved pattern to refract the R, G, and B color components of the image signals at different angles from each other in accordance with the respective wavelengths. The refraction angles of the respective R, G, and B color components of the image signals are determined in advance such that each image signal progresses by constant distances within the waveguide 820.

The waveguide 820 serves as the signal transmission medium to transmit the R, G, and B color components of the image signals inputted through the grating 810 in a predetermined direction. The image signals may be reflected without any losses where the total reflections of the image signals are ideal when the image signals to be transmitted through the waveguide 820 collide s against the inner side of the waveguide 820. Actually, the image signals are subject to considerable losses. Therefore, in order to prevent the losses of the image signals, a high reflective material such as aluminum (Al) 840 is coated on the portions of the inner side of the waveguide 820 where the image signals collide s during the transmissions of the image signals within the waveguide 820.

The ocular lens 830 is attached on the outer surface of the waveguide 820, and outputs the R, G, and B color components of the image signals transmitted through the waveguide 820. The ocular lens 830 is placed in accordance with the above-described microscope principle. When the image is made from the R, G, and B image signals magnified by the objective lens 800 within the focusing distance of the ocular lens 830, the ocular lens 830 magnifies and shows the image to the user. To raise an order of magnification of the image, the focusing distance of the ocular lens 830 may be reduced. In order to reduce the focusing distance, the diameter of the ocular lens 830 may be reduced. However, in an aspect of the present invention, because the order of magnification can be raised or lowered using the movement of the objective lens 800, i.e., by adjusting the focusing distance of the objective lens 800, the ocular lens 830 can have a sufficiently large diameter to ensure visibility of the user's eye, i.e., the exit pupil.

In the aspect described above, the grating 810 may be integrated with the waveguide 820, and implemented using the hologram optics element (HOE).

In the aspect shown in FIG. 8, the grating 810 is a multiplexing type grating that respectively acts in regard to the color components of the R, G, and B color components of the image signals within a single element for transmitting, or reflects in case of reflection type, the R, G, and B color components of the image signals at predetermined refraction angles, respectively.

Further, the ocular lens 830 in the aspect of FIG. 8 is the multiplexing type lens for refracting the R, G, and B color components of the image signals at different angles with each other so that the R, G, and B color components of the image signals make the image at a same focus.

In the aspect described above, the ocular lens 830 may be integrated with the waveguide 820, and implemented using the hologram optics element.

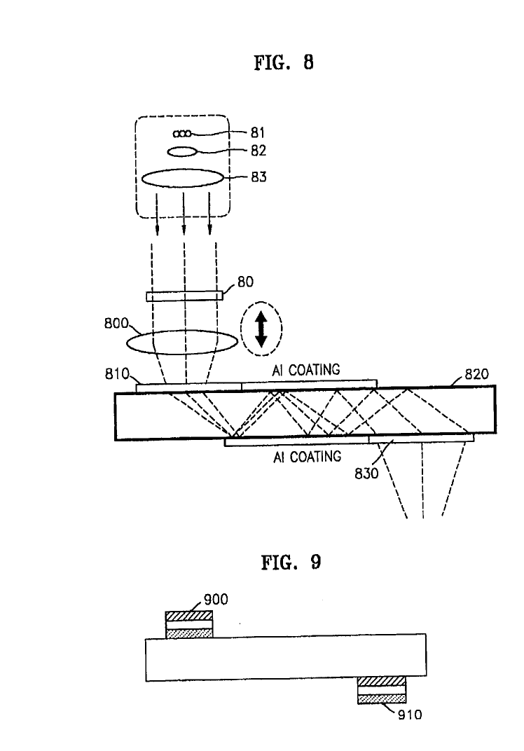

FIG. 9 shows an assembly of a waveguide, a grating, and a lamination type ocular lens incorporated in the wearable color display system to display the color signals or the R, G, and B color components of the image signals shown in FIG. 8. In the assembly shown in FIG. 9, a lamination type grating 900 and a lamination type ocular lens 910 are attached to the waveguide.

The lamination type grating 900 shown in FIG. 9 is embodied by laminating layers, each of which refracts only one of the R, G, and B color components of the image signals at an angle predetermined in accordance with the signals' wavelengths.

The lamination type ocular lens 910 shown in FIG. 9 is embodied by laminating layers in a predetermined order, each of which refracts only one of the R, G, and B color components of the image signals at an angle predetermined in accordance with the signals' wavelengths, and the R, G, and B color components of the image signals respectively refracted via the corresponding layer converge to an identical focus to make a combined image.

The wearable color display system according to the present invention can be implemented through various combinations of a multiplexing type and a lamination type as for the grating and the ocular lens. Further, the wearable color display system, according to an aspect of the present invention, can be implemented to have such structures that are shown in FIGS. 6(a) through 7(d), respectively.

Although the aspects of the present invention have been shown and described in regard to a monocular type construction, the same functions and principles as described above can be applied to implement a binocular system.

According to the present invention, it is possible to implement a display system wearable like glasses using small and light elements, which provides a highly magnified image and visible image to a user by primarily magnifying an image to be displayed via a refraction element and additionally magnifying the image via an ocular lens.

While the present invention has been particularly shown and described with reference to preferred aspects thereof, it will be understood by those of ordinary skill in the art that various changes in form and details may be made therein without departing from the spirit and scope of the present invention as defined by the appended claims.

What is claimed is:

1. A wearable display system to display an input image signal, comprising:
an objective lens magnifying the input image signal;
a grating refracting the input image signal magnified by the objective lens at a predetermined angle;
a waveguide transmitting the input image signal refracted by the grating; and
an ocular lens making an image corresponding to the input image signal transmitted via the waveguide, allowing a user to see the input image signal.

2. The wearable display system according to claim 1, wherein an order of magnification of the input image signal is adjusted by varying focusing distances of the objective lens and/or the ocular lens.

3. The wearable display system according to claim 1, wherein the objective lens is movable to an input direction of the input image signal to adjust an order of magnification.

4. The wearable display system according to claim 1, wherein the waveguide is movable to an input direction of the image signal to adjust an order of magnification.

5. The wearable display system according to claim 1, wherein the waveguide comprises:
a coating plate of a highly reflective material to reflect and transmit the input image signal.

6. The wearable display system according to claim 1, wherein the grating is a hologram optics element.

7. The wearable display system according to claim 1, wherein the input image signal is produced at a focusing distance of the objective lens.

8. A wearable color display system to display red (R), green (G), and blue (B) color components of input image signals, comprising:
an objective lens magnifying the R, G, and B input image signals;
a grating refracting the R, G, and B color components of the input image signals magnified by the objective lens at predetermined angles;
a waveguide transmitting the R, G, and B color components of the input image signals refracted by the grating; and
an ocular lens making an image corresponding to the R, G, and B color components of the input image signals transmitted via the waveguide, allowing a user to see the input image signals.

9. The wearable color display system according to claim 8, wherein orders of magnification of the R, G, and B color components of the input image signals are adjusted by varying focusing distances of the objective lens and/or the ocular lens.

10. The wearable color display system according to claim 8, wherein the objective lens is movable to an input direction of the R, G, and B color components of the input image signals to adjust orders of magnification.

11. The wearable color display system according to claim 8, wherein the waveguide is movable to an input direction of the R, G, and B color components of the input image signals to adjust orders of magnification.

12. The wearable color display system according to claim 8, wherein the waveguide comprises:
a coating plate of a highly reflective material to reflect and transmit the R, G, and B color components of the input image signals.

13. The wearable color display system according to claim 8, wherein the grating is a hologram optics element.

14. The wearable color display system according to claim 8, wherein the R, G, and B color components of the input image signals are produced at a focusing distance of the objective lens.

15. The wearable color display system according to claim 8, wherein the grating is a multiplexing type grating to respectively refract the R, G, and B color components of the image signals at different angles from each other according to corresponding wavelengths, where the R, G, and B color components of the input image signals respectively move at constant distances within the waveguide.

16. The wearable color display system according to claim 8, wherein the grating is a lamination type grating having layers laminated in a predetermined order, where each layer refracts only one of the R, G, and B color components of the input image signals at an angle predetermined in accordance with corresponding wavelengths of the R, G, and G color components of the input image signals.

17. The wearable color display system according to claim 8, wherein the ocular lens is a multiplexing type lens to respectively refract and output the R, G, and B color components of the image signals at different angles from each other according to corresponding wavelengths, where the R, G, and B color components of the input image signals converge to an identical focus to make a combined image.

18. The wearable color display system according to claim 8, wherein the ocular lens is a lamination type lens having layers laminated in a predetermined order where, each of which refracts only one of the R, G, and B input image signals at an angle predetermined in accordance with corresponding wavelengths, and the R, G, and B color components of the image signals respectively refracted via the corresponding layer converge to an identical focus to make a combined image.
